(19) United States
(12) Patent Application Publication
(10) Pub. No.: US 2010/0295530 A1
(43) Pub. Date: Nov. 25, 2010

(54) Power supply voltage control circuit

(75) Inventors: Yoshifumi Ikenaga, Kanagawa (JP); Masahiro Nomura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/662,710

(22) Filed: Apr. 29, 2010

(30) Foreign Application Priority Data
May 19, 2009 (JP) 2009-120747

(51) Int. Cl. H02J 4/00

(52) U.S. Cl. 323/318

(57) ABSTRACT

A power supply voltage control circuit controls power supply voltage supplied to a target circuit that performs certain signal processing. The power supply voltage control circuit includes a control signal generation circuit that selectively generates first and second control signals when the power supply voltage supplied to the target circuit is increased from a first power supply voltage to a second power supply voltage, the second power supply voltage being higher than the first power supply voltage, and a power supply circuit that increases the power supply voltage toward a voltage level of the second power supply voltage based on the first control signal, or increases the power supply voltage to a voltage level higher than the second power supply voltage first and subsequently decreases the power supply voltage to the second power supply voltage based on the second control signal.

### INCORPORATION BY REFERENCE

This application is based upon and claims the benefit of priority from Japanese patent application No. 2009-120747, filed on May 19, 2009, the disclosure of which is incorporated herein in its entirety by reference.

### BACKGROUND

1. Field of the Invention

The present invention relates to a power supply voltage control circuit, and more particularly, to a power supply voltage control circuit that controls power supply voltage in high speed.

2. Description of Related Art

A Dynamic Voltage and Frequency Scaling (DVFS) that controls power supply voltage according to operation frequency requested from outside (hereinafter referred to as request frequency) is effective as a method of reducing power consumption in a semiconductor integrated circuit using a CMOS logical gate. When there is a change in the request frequency, power supply voltage needs to be controlled to the optimal voltage value in high speed in order to reduce energy consumed in the semiconductor integrated circuit or to shorten a period in which the power supply voltage is insufficient.

Even when the request frequency is the same, the optimal voltage of the power supply voltage varies depending on the environment such as temperature. Thus, the power supply voltage needs to be controlled while comparing the relation between the request frequency with the operation frequency of the actual circuit using a delay monitor or the like. There exist two principal methods to control the power supply voltage when the request frequency is increased from speed 1 to speed 2 (speed 1<speed 2), for example. The first method is to check whether the operation frequency of the circuit satisfies the request frequency while monotonically increasing the power supply voltage. However, in this method, when the difference between an optimal voltage value 1 corresponding to the speed 1 and an optimal voltage value 2 corresponding to the speed 2 is large, it takes time for the power supply voltage to reach the optimal voltage value 2. In short, the period in which the circuit cannot operate in stable condition is increased.

The second method is a method of controlling the power supply voltage as disclosed in Japanese Unexamined Patent Application Publication No. 2001-244421. As shown in FIG. 15, by increasing the power supply voltage to a maximum voltage value first and subsequently decreasing it to the optimal voltage value 2, the period in which the circuit cannot operate in stable condition can be shortened. However, in this method, it takes long time to reach the optimal voltage value 2 from the maximum voltage value when the difference between the optimal voltage value 1 corresponding to the speed 1 and the optimal voltage value 2 corresponding to the speed 2 is small. In short, the power consumption during this time increases.

Japanese Unexamined Patent Application Publication No. 2004-248475 discloses a charge pump circuit that boosts the power supply voltage. This charge pump circuit includes a plurality of charge pump units and a control circuit that controls them. The control circuit increases the number of charge pump units that are activated when the charge pump voltage generated by the charge pump unit becomes lower than a first target voltage. On the other hand, when the charge pump voltage is changed to be higher than a second target voltage that is lower than the first target voltage, the control circuit decreases the number of charge pump units that are activated. In this way, the amplitude of the charge pump voltage is suppressed to be low.

### SUMMARY

The present inventors have found a problem in the power supply voltage control circuit according to related arts that, as described above, it is impossible to control the power supply voltage in high speed.

A first exemplary aspect of the present invention is a power supply voltage control circuit that controls power supply voltage supplied to a target circuit, the target circuit performing certain signal processing, the power supply voltage control circuit including a control signal generation circuit that selectively generates first and second control signals when the power supply voltage supplied to the target circuit is increased from a first power supply voltage to a second power supply voltage, the second power supply voltage being higher than the first power supply voltage, and a power supply circuit that increases the power supply voltage toward a voltage level of the second power supply voltage based on the first control signal, or increases the power supply voltage to a voltage level higher than the second power supply voltage first and subsequently decreases the power supply voltage to the second power supply voltage based on the second control signal.

According to the circuit structure as above, it is possible to control the power supply voltage in high speed.

According to the present invention, it is possible to provide the power supply voltage control circuit that makes it possible to control the power supply voltage in high speed.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing the whole structure of a semiconductor integrated circuit according to a first exemplary embodiment of the present invention;

FIG. 2 is a circuit diagram showing the structure of a power supply circuit according to the first exemplary embodiment of the present invention;

FIG. 3 is a circuit diagram showing the structure of a reference voltage generation circuit according to the first exemplary embodiment of the present invention;

FIG. 4 is a circuit diagram showing the structure of a control circuit according to the first exemplary embodiment of the present invention;

FIG. 5 is a circuit diagram showing the structure of a threshold voltage generation circuit according to the first exemplary embodiment of the present invention;

FIG. 6 is a circuit diagram showing the structure of a difference voltage generation circuit according to the first exemplary embodiment of the present invention;

FIG. 7 is a circuit diagram showing the structure of a speed monitoring circuit according to the first exemplary embodiment of the present invention;

FIG. 8 is a circuit diagram showing the structure of a selection circuit according to the first exemplary embodiment of the present invention;

FIG. 9 is a circuit diagram showing another structure of the reference voltage generation circuit according to the first exemplary embodiment of the present invention;

FIG. 10 is a circuit diagram showing another structure of the control circuit according to the first exemplary embodiment of the present invention;

FIG. 11 is a circuit diagram showing the structure of a delay ratio monitor according to the first exemplary embodiment of the present invention;

FIG. 12 is a circuit diagram showing the structure of a control circuit according to a second exemplary embodiment of the present invention;

FIG. 13 is a circuit diagram showing the structure of a selection circuit according to the second exemplary embodiment of the present invention;

FIG. 14 is a circuit diagram showing the structure of a control circuit according to a third exemplary embodiment of the present invention;

FIG. 15 is a timing chart showing a control method of a power supply voltage control circuit according to a related art;

FIG. 16 is a timing chart showing a control method of the power supply voltage control circuit according to the first exemplary embodiment of the present invention; and

FIG. 17 is a timing chart showing a control method of the power supply voltage control circuit according to the first exemplary embodiment of the present invention.

### DETAILED DESCRIPTION OF THE EXEMPLARY EMBODIMENTS

Hereinafter, specific exemplary embodiments to which the present invention is applied will be described in detail with reference to the drawings. Throughout the drawings, the same components are denoted by the same reference symbols, and overlapping description will be omitted as appropriate for the sake of clarity.

### First Exemplary Embodiment

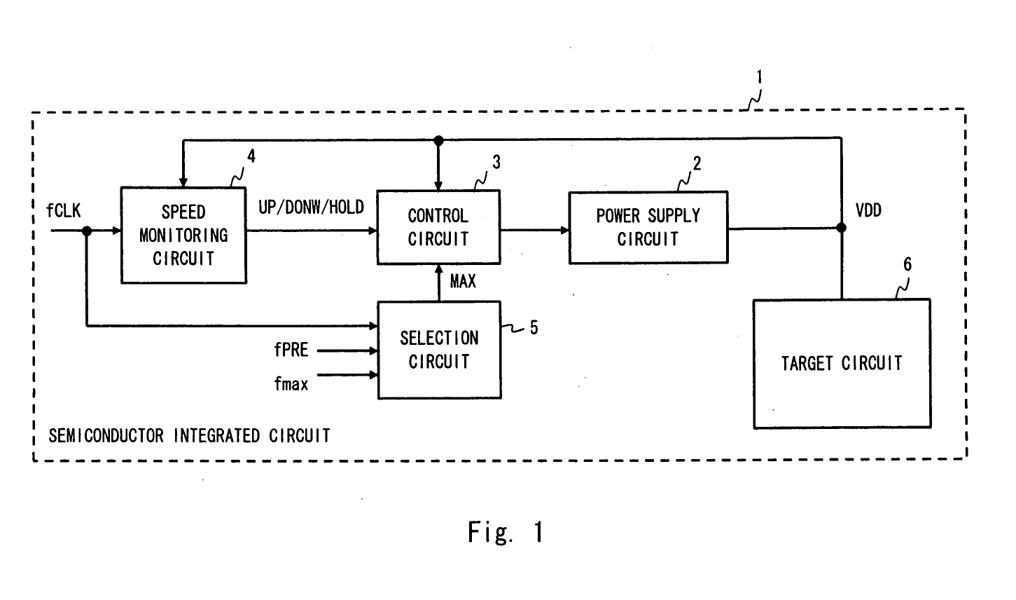

The first exemplary embodiment of the present invention will be described in detail with reference to the drawings. FIG. 1 is a semiconductor integrated circuit 1 that includes a power supply voltage control circuit according to the first exemplary embodiment of the present invention. The circuit shown in FIG. 1 includes a power supply circuit 2 that generates power supply voltage VDD, a control circuit (control signal generation circuit) 3 that controls output voltage (power supply voltage VDD) of the power supply circuit 2 according to a plurality of control methods, a selection circuit 5 that selects the control method of the control circuit 3, a target circuit 6 that is driven by the power supply voltage VDD from the power supply circuit 2, and a speed monitoring circuit (delay time detection circuit) 4 that detects operation frequency of the target circuit 6. The power supply voltage control circuit is composed of the power supply circuit 2, the control circuit 3, the speed monitoring circuit 4, and the selection circuit 5.

A clock signal fCLK of an operation frequency (request frequency f2) requested from outside to the target circuit 6 is input to one input terminal of the speed monitoring circuit 4, and a first input terminal of the selection circuit 5. The power supply voltage VDD output from the power supply circuit 2 is input to the other input terminal of the speed monitoring circuit 4, an input terminal of the target circuit 6, and a first input terminal of the control circuit 3. An output signal (monitor result) of the speed monitoring circuit 4 is input to a second input terminal of the control circuit 3. A clock signal fPRE of an operation frequency (request frequency f1) set for the target circuit 6 in advance is input to a second input terminal of the selection circuit 5. Further, a clock signal of a maximum operation frequency fmax is input to a third input terminal of the selection circuit 5. An output signal (switching control signal MAX) of the selection circuit 5 is input to a third input terminal of the control circuit 3. An output signal (control signal) of the control circuit 3 is input to an input terminal of the power supply circuit 2.

The speed monitoring circuit 4 outputs to the control circuit 3 the result obtained by comparing the operation frequency (f2) requested from outside with an operation frequency (fop) of the target circuit 6. For example, when the operation frequency requested for the target circuit 6 is increased from the request frequency f1 to the request frequency f2 (f1<f2), the control circuit 3 outputs the control signal to increase the power supply voltage VDD until when the operation frequency of the target circuit 6 satisfies the request frequency f2. The power supply circuit 2 generates the power supply voltage VDD based on the control signal, and outputs the generated voltage to the target circuit 6.

There are two methods as a method of controlling the power supply voltage VDD when the operation frequency requested for the target circuit 6 is increased from the request frequency f1 to the request frequency f2, for example. The first one is to monotonically increase the power supply voltage VDD to the optimal voltage so that the operation frequency of the target circuit 6 satisfies the request frequency. The second one is to increase the power supply voltage VDD to the maximum voltage VMAX first, and subsequently decrease VDD to the optimal voltage. The power supply voltage control circuit shown in FIG. 1 selects one of the two voltage control methods based on the switching control signal MAX output from the selection circuit 5, so as to control the power supply voltage.

More specifically, the selection circuit 5 compares a ratio of the request frequency f1 before change to the request frequency f2 after change with a ratio of the request frequency f2 to the maximum operation frequency fmax of the target circuit 6. When fmax/f2 is larger than f2/f1, the power supply voltage VDD is monotonically increased until when the operation frequency (fop) of the target circuit 6 becomes equal to or slightly larger than the request frequency f2. The operation frequency fop of the target circuit 6 is detected from the speed monitoring circuit 4. On the other hand, when fmax/f2 is smaller than f2/f1, the power supply voltage VDD is firstly increased to the maximum voltage VMAX, and subsequently VDD is decreased to the optimal voltage. The optimal voltage is controlled so that the operation frequency fop of the target circuit 6 becomes equal to or slightly larger than the request frequency f2.

When the power supply voltage VDD is controlled by the output signal (monitor result) from the speed monitoring circuit 4, the power supply voltage VDD is controlled by step-by-step means so that the change ratio of the operation frequency fop per one step of the voltage change becomes constant. When employing the method of firstly increasing the power supply voltage VDD to the maximum voltage VMAX, there is no need to monitor the operation frequency fop of the target circuit 6 by the speed monitoring circuit 4. In summary, the power supply voltage VDD that satisfies the request frequency f2 is supplied without monitoring the operation frequency fop. Hence, the time required to control the power supply voltage VDD is extremely short. In this way, by selecting one of the control methods, it is possible to suppress increase of power consumption and to shorten the time required to control the power supply voltage. In summary, the optimal power supply voltage VDD can be controlled no matter which values the request frequencies f1, f2 may have.

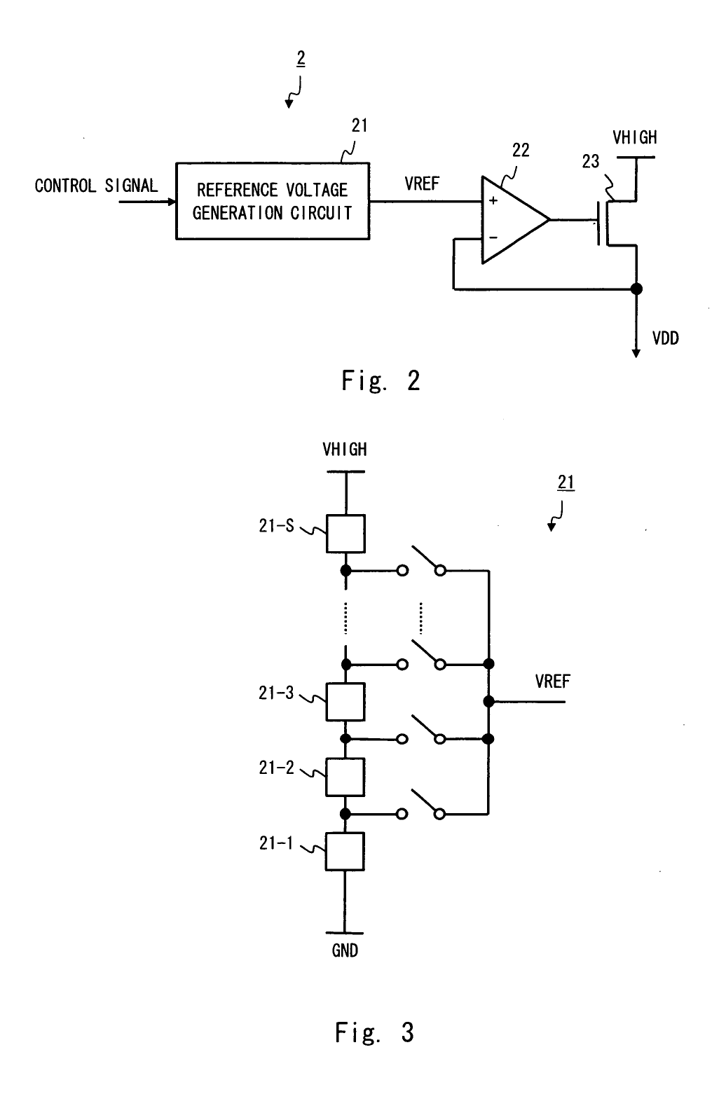

FIG. 2 shows the circuit structure of the power supply circuit 2. The power supply circuit 2 includes a reference voltage generation circuit 21, an operational amplifier 22, and an N channel MOS transistor 23. The control signal from the control circuit 3 is input to the reference voltage generation circuit 21. An output voltage VREF from the reference voltage generation circuit 21 is input to a non-inverting input terminal of the operational amplifier 22. Further, an output signal of the operational amplifier 22 is supplied to a gate of the transistor 23. A drain of the transistor 23 is connected to a high-potential side power supply terminal VHIGH. A source of the transistor 23 is connected to an output terminal of the power supply circuit 2 and an inverting input terminal of the operational amplifier 22. In summary, the power supply voltage VDD output from the output terminal of the power supply circuit 2 is controlled to satisfy VDD=VREF. In the power supply circuit 2, the reference voltage generation circuit 21 is controlled by the control signal from the control circuit 3. The power supply circuit 2 then outputs the power supply voltage VDD according to the reference potential VREF.

FIG. 3 shows the circuit structure of the reference voltage generation circuit 21. The reference voltage generation circuit 21 includes S (S is a natural number) resistors 21-1 to 21-S that are connected in series, and S-1 switches that are provided between each node between the resistors and the output terminal of the reference voltage generation circuit 21. Among the switches, only one of the switches that is selected is in ON state. At this time, the output voltage VREF output from the output terminal of the reference voltage generation circuit 21 is substantially equal to the potential of the node that is connected through the switch that is turned on. The ON/OFF of the switch is controlled by the control circuit 3.

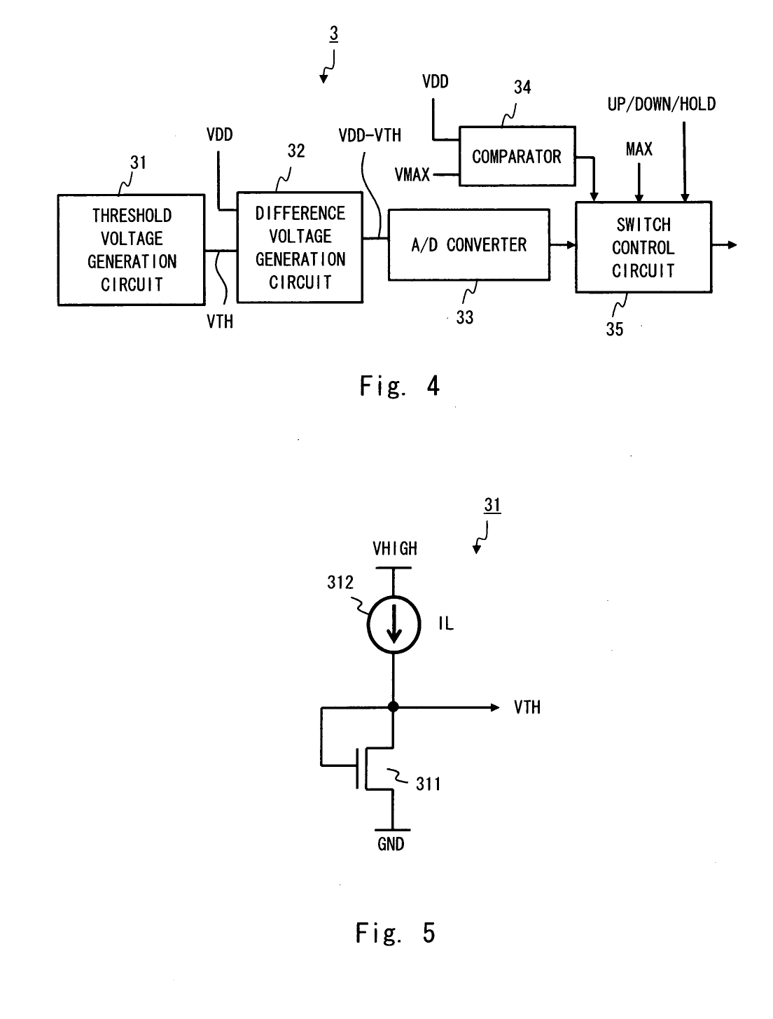

FIG. 4 shows the circuit structure of the control circuit 3. The control circuit 3 includes a threshold voltage generation circuit 31 that generates threshold voltage VTH of a critical path in the target circuit 6, a difference voltage generation circuit 32 that outputs difference voltage between the power supply voltage VDD and the threshold voltage VTH, an. A/D converter 33 that converts the output of the difference voltage generation circuit 32 to a digital value, a comparator 34 that compares the maximum voltage VMAX that may be supplied to the target circuit 6 with the power supply voltage VDD, and a switch control circuit 35. The threshold voltage VTH here means the threshold voltage of the MOS transistor included in the critical path of the target circuit 6.

The threshold voltage VTH generated by the threshold voltage generation circuit 31 is input to one input terminal of the difference voltage generation circuit 32. The power supply voltage VDD generated by the power supply circuit 2 is input to the other input terminal of the difference voltage generation circuit 32, and one input terminal of the comparator 34. Further, the maximum voltage VMAX is input to the other input terminal of the comparator 34. The difference voltage (VDD−VTH) generated by the difference voltage generation circuit 32 is input to an input terminal of the A/D converter 33. An output signal of the A/D converter 33 is input to the switch control circuit 35. To the switch control circuit 35, the comparison result of the comparator 34, the switching control signal MAX of the selection circuit 5, and the monitor result of the speed monitoring circuit 4 are further input.

The operation frequency f of the circuit can be typically expressed by the following approximation using the power supply voltage VDD and the threshold voltage VTH.

f=A(V_{DD}−V_{TH}) (1)

From the expression (1), the change rate of the operation frequency f when the power supply voltage VDD is changed can be expressed as the following expression (2).

$$\frac{\partial f}{\partial {V}_{DD}} \cdot \frac{1}{f} = \frac{1}{{V}_{DD} - {V}_{TH}} \qquad ( 2 )$$

Accordingly, if the control speed of the power supply voltage VDD is expressed by the following expression (3), the change rate of the operation frequency f per hour will be expressed by the expression (4).

$$\begin{matrix}\frac{\partial {V}_{DD}}{\partial t} = k \cdot ( {V}_{DD} - {V}_{TH} ) & ( 3 ) \\ \frac{\partial f}{\partial t} \cdot \frac{1}{f} = k & ( 4 )\end{matrix}$$

k is a constant number.

If the voltage change amount per one step of the voltage change is controlled to be proportional to VDD−VTH, the power supply voltage can be changed while constantly keeping the change rate of the operation frequency fop per one step of the voltage change constant. FIG. 5 shows one example of the circuit structure of the threshold voltage generation circuit 31. The threshold voltage generation circuit 31 includes a constant current source 312 in which current having current value IL flows, and an N channel MOS transistor 311. A low-potential side power supply terminal GND is connected to a source of the N channel MOS transistor 311. A gate and a drain of the N channel MOS transistor 311 are connected to an output terminal of the current source 312. A high-potential side power supply terminal VHIGH is connected to an input terminal of the current source 312. The gate potential of the N channel MOS transistor 311 is output from the threshold voltage generation circuit 31 as the threshold voltage VTH.

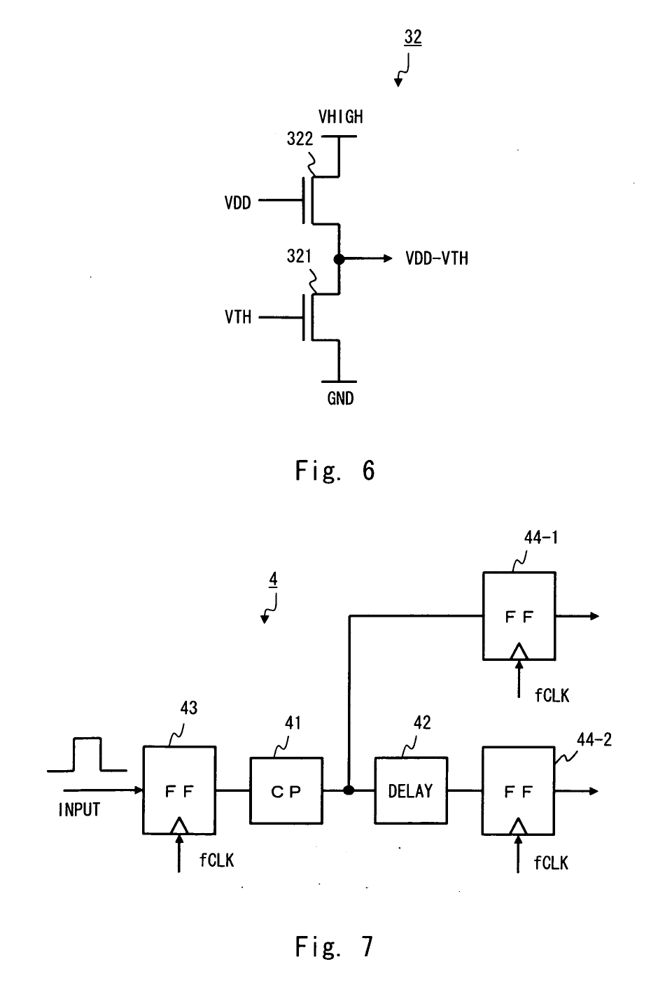

FIG. 6 shows one example of the circuit structure of the difference voltage generation circuit 32. The difference voltage generation circuit 32 includes N channel MOS transistors 321 and 322. The high-potential side power supply terminal VHIGH is connected to a drain of the transistor 322. A drain of the transistor 321 and an output terminal of the difference voltage generation circuit 32 are connected to a source of the transistor 322. A low-Potential side power supply terminal GND is connected to a source of the transistor 321. An output voltage VTH from the threshold voltage generation circuit 31 is supplied to a gate of the transistor 321. Further, the power supply voltage VDD is supplied to a gate of the transistor 322.

As drain currents flowing in the N channel MOS transistors 321, 322 are equal to each other, the gate-source voltage of each transistor is equal to each other. Therefore, the gate-source voltage of the transistor 321 is denoted by VTH. The gate-source voltage of the transistor 322 is also denoted by VTH. Thus, the source potential of the transistor 322 is denoted by VDD−VTH.

In FIG. 4, the switch control circuit 35 outputs the control signal to the power supply circuit 2 to control the power supply voltage VDD based on the comparison result (UP/DOWN/HOLD signal) from the speed monitoring circuit 4, the switching control signal MAX from the selection circuit 5, the comparison result from the comparator 34, and the output signal from the A/D converter 33. The comparator 34 compares the power supply voltage VDD with the maximum voltage VMAX, and outputs the comparison result. The comparator 34 outputs the signal to the switch control circuit 35 so as to cancel the switching control signal MAX at a time when the power supply voltage VDD reaches the maximum voltage VMAX. In summary, the switch control circuit 35 outputs the control signal (second control signal) to set the power supply voltage VDD to the maximum voltage VMAX while the switching control signal MAX is activated. On the other hand, when the switching control signal MAX is cancelled (non-activated), the switch control circuit 35 outputs the control signal to control the power supply voltage VDD according to the UP/DOWN/HOLD signal. In summary, when the UP signal is output, the switch control circuit 35 outputs the control signal (first control signal) to monotonically increase the power supply voltage VDD to the optimal voltage value. When the DOWN signal is output, the switch control circuit 35 outputs the control signal (third control signal) to monotonically decrease the power supply voltage VDD to the optimal voltage. When the HOLD signal is output, the switch control circuit 35 outputs the control signal (fourth control signal) to keep the power supply voltage VDD. For example, when the power supply voltage VDD reaches the maximum voltage VMAX and the switching control signal MAX is cancelled, the power supply voltage VDD is decreased to the optimal voltage by the DOWN signal. The voltage change amount per one step of the power supply control at this time is determined based on the output of the A/D converter 33 as described above.

FIG. 7 shows the circuit structure of the speed monitoring circuit 4. The speed monitoring circuit 4 includes a critical path replica (hereinafter simply referred as CP) 41 having substantially the same delay time as the critical path delay of the target circuit 6, a delay element 42 having a certain delay time, and flip-flops (hereinafter simply referred as FFs) 43, 44-1, 44-2 located at the previous and the subsequent stages of the CP 41 and the delay element 42. The CP 41 may have the same structure as the target circuit 6, for example. A certain input signal is input to the FF 43. An output signal of the FF 43 is input to the CP 41. An output signal of the CP 41 is input to the FF 44-1, and to the FF 44-2 through the delay element 42. The CP 41 and the delay element 42 are supplied with the power supply voltage VDD that is equal to that input to the target circuit 6. In summary, the CP 41 and the delay element 42 are driven by the power supply voltage VDD as is similar to the target circuit 6. Each FF is operated in synchronization with the clock signal fCLK of the operation frequency (request frequency f2) requested next by the target circuit 6. The signal output from the FF 43 is received by the FFs 44-1 and 44-2 in synchronization with the next clock signal fCLK. Thus, the speed monitoring circuit 4 compares magnitude relation of one clock cycle of the clock signal fCLK with the critical path delay. The output result of the FFs 44-1, 44-2 is output as the monitor result of the speed monitoring circuit

When the output signal from the FF 43 does not reach FF44-1 in one clock cycle of the clock signal fCLK, the operation frequency of the target circuit 6 does not satisfy the request frequency f1. Hence, the speed monitoring circuit 4 outputs the UP signal. On the other hand, when the output signal from the FF 43 reaches the FF 44-2 in one clock cycle of the clock signal fCLK, the operation frequency fop of the target circuit 6 is much faster than the request frequency f2. Thus, the speed monitoring circuit 4 outputs the DOWN signal. Otherwise, the HOLD signal is output to keep the power supply voltage VDD to the value that is currently set.

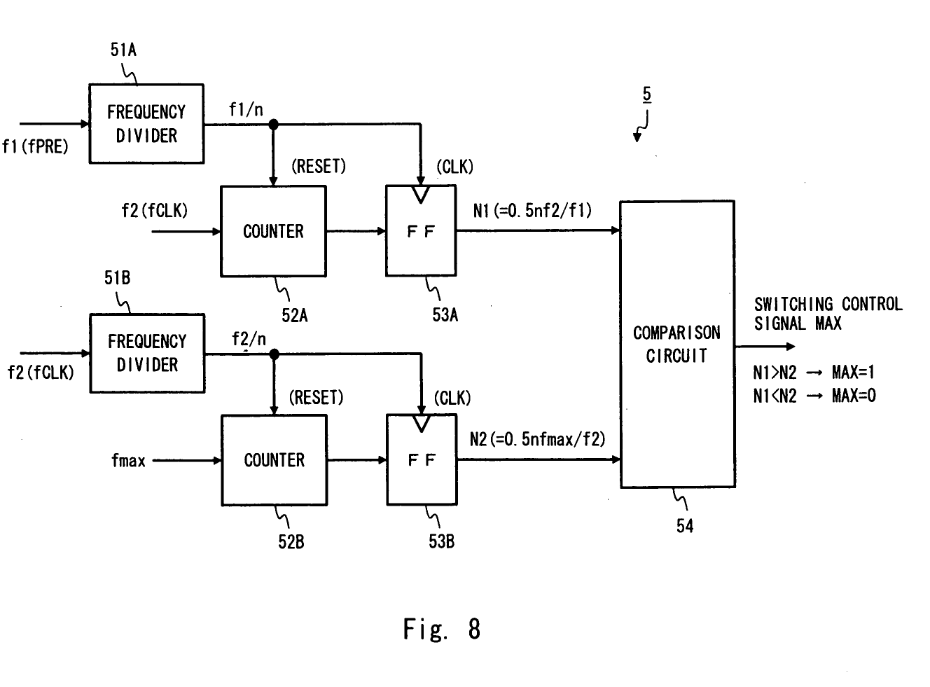

FIG. 8 shows a circuit diagram of the selection circuit 5. The selection circuit 5 includes frequency dividers 51A, 51B, counters 52A, 52B, FFs 53A, 53B, and a comparison circuit 54. The clock signal fPRE of the request frequency f1 is input to the frequency divider 51 A. An output signal of the frequency divider 51A is input to a reset input terminal of the counter 52A and a clock input terminal of the FF 53A. The clock signal fCLK of the request frequency f2 is input to an input terminal of the counter 52A. An output signal of the counter 52A is input to an input terminal of the FF 53A. An output signal of the FF 53A is input to one input terminal of the comparison circuit 54. A clock signal fCLK of the request frequency f2 is input to the frequency divider 51B. An output signal of the frequency divider 51B is input to a reset input terminal of the counter 52B and a clock input terminal of the FF 53B. A clock signal of the operation frequency fmax is input to an input terminal of the counter 52B. An output signal of the counter 52B is input to an input terminal of the FF 53B. An output signal of the FF 53B is input to the other input terminal of the comparison circuit 54. An output signal of the comparison circuit 54 is output as the switching control signal MAX of the selection circuit 5.

More specifically, when the request frequency to the target circuit 6 is changed from f1 to f2 (f2>f1), the selection circuit 5 is operated so that the clock signal fCLK of the frequency f2 is input to the counter 52A. Further, the frequency divider 51A divides the frequency of the clock signal fPRE of the frequency f1 by n (n is a natural number) and outputs the signal. The output signal of the frequency divider 51A is input to the counter 52A as a reset signal and input to the FF 53A as a clock input signal. The counter 52A counts the clock signal fCLK of the frequency f2. The FF 53A receives the count value while the reset signal of the counter 52A is turned on.

By such operation, in the counter 52A, the number of pulses of the frequency f2 at the period of 0.5 n/f1 is measured. Hence, the value of N1=0.5 n*f2/f1 is obtained as the output result N1 of the FF 53A.

In the same way, the value of N2=0.5 n*fmax/f2 is obtained as the output result N2 of the FF 53B. Note that fmax is the maximum operation frequency that can be input to the target circuit 6 when the target circuit 6 is supplied with the power supply voltage VMAX. When N1 >N2, or f2/f1>fmax/f2, the comparison circuit 54 outputs “1” as the control signal MAX, and otherwise outputs “0”.

To realize the above circuit operation, the clock signal fPRE before switching the request frequency (request frequency f1), the clock signal fCLK after switching the request frequency (request frequency f2), and the clock signal of the maximum operation frequency fmax are input to the selection circuit 5. The frequency of the clock signal fPRE is request frequency f1 and the frequency of the clock signal fCLK is request frequency f2 immediately after the request frequency is switched. The frequency of the clock signal fPRE is request frequency f2 after the HOLD signal is output from the speed monitoring circuit 4 (after the completion of the power supply control).

When the power supply voltage is controlled so that the change ratio of the operation frequency per one step of the voltage change becomes constant, the number of steps N required to control the voltage is expressed as follows. When the power supply voltage VDD is monotonically increased, N=logₐ (f2/f1) is established. On the other hand, when the power supply voltage VDD is increased to the maximum voltage VMAX first and subsequently decreased to the optimal voltage, N=logₐ (fmax/f2)+A is established. In this expression, A indicates the number of steps corresponding to the time required to increase the power supply voltage VDD to VMAX. The time required to increase the power supply voltage VDD to a certain target voltage (maximum voltage VMAX) is extremely short compared with a case of controlling the power supply voltage VDD based on the monitor result of the speed monitoring circuit 4. In short, logₐ (fmax/f2)>>A is established. When fmax/f2>f2/f1, the power supply voltage VDD is monotonically increased. On the other hand, when fmax/f2<f2/f1, the power supply voltage VDD is increased to the maximum voltage VMAX first, and subsequently monotonically decreased to the optimal voltage. Hence, the number of steps required to control the power supply can be reduced. In this example, one of two control methods is selected based on the control signal MAX output from the selection circuit 5. In the first exemplary embodiment, the request frequency f2 when fmax/f2=f2/f1 is established is called reference frequency.

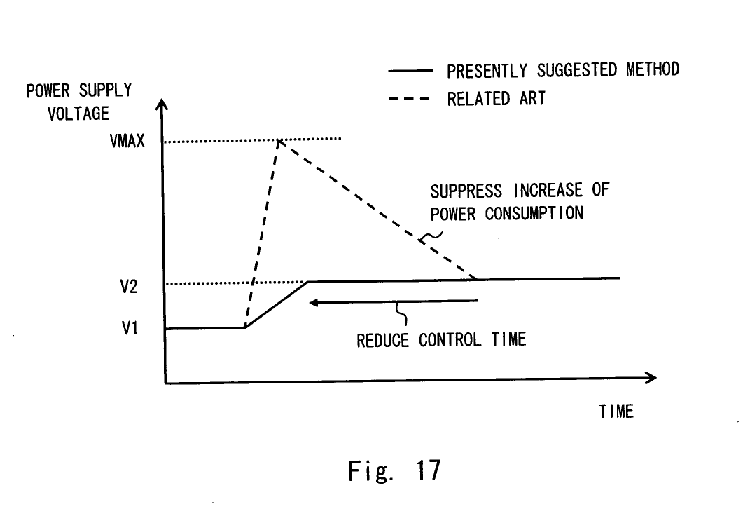

As described above, by employing the power supply voltage control circuit according to the first exemplary embodiment of the present invention, it is possible to select the optimal power supply voltage control method according to the change of the request frequency. Hence, the time required to control the power supply can be minimized. Further, the increase of the power consumption can be suppressed. More specifically, for example, when the voltage V2 corresponding to the request frequency f2 is larger than a certain voltage value (reference voltage), as shown in FIG. 16, the power supply voltage VDD is increased to the maximum voltage VMAX first, and subsequently it is monotonically decreased to the voltage V2. On the other hand, when the power supply voltage V2 is smaller than a certain voltage value (reference voltage), as shown in FIG. 17, the power supply voltage VDD is monotonically increased.

In the first exemplary embodiment, when the switching control signal MAX=“1” is input to the control circuit 3, the switch control circuit 35 provided in the control circuit 3 transmits the control signal to indicate VREF=VMAX to the reference voltage generation circuit 21 provided in the power supply circuit 2. However, it is not limited to this example. For example, the switch control circuit 35 may transmit the control signal to indicate a certain target voltage to show VREF>VMAX to the reference voltage generation circuit 21. Accordingly, it is possible to shorten the time required for the power supply voltage VDD to reach the maximum voltage VMAX.

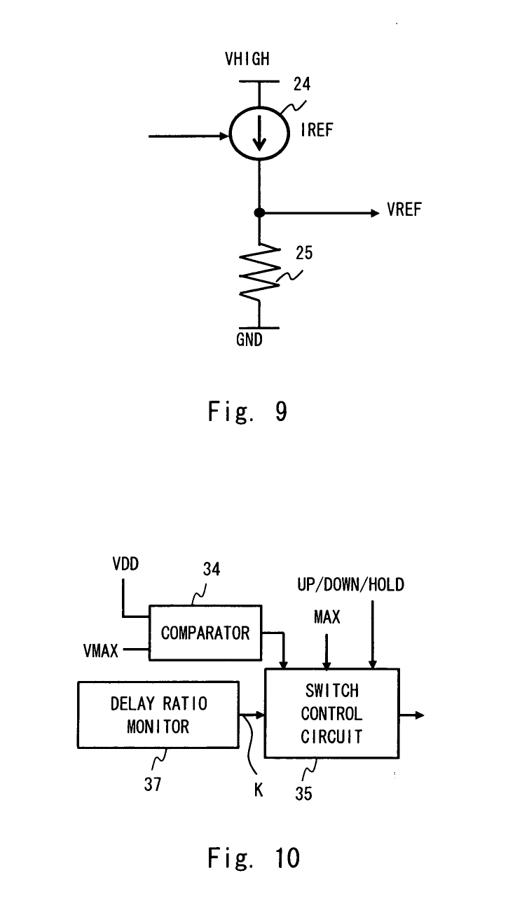

Furthermore, in the first exemplary embodiment, the reference voltage generation circuit 21 outputs any one of the potentials generated by the resistance voltage division as the output voltage VREF. However, the circuit structure is not limited to this. The circuit may have any structure as long as the output voltage can be controlled according to the input control signal. For example, as shown in FIG. 9, the reference voltage generation circuit 21 may have the structure that includes a constant current source 24 where current IREF is controlled according to the control signal, and a resistance element 25 that is connected to the constant current source 24 in series and has a fixed resistance value R. In this case, the output signal VREF of the reference voltage generation circuit 21 is output from a node that connects the constant current source 24 and the resistance element 25.

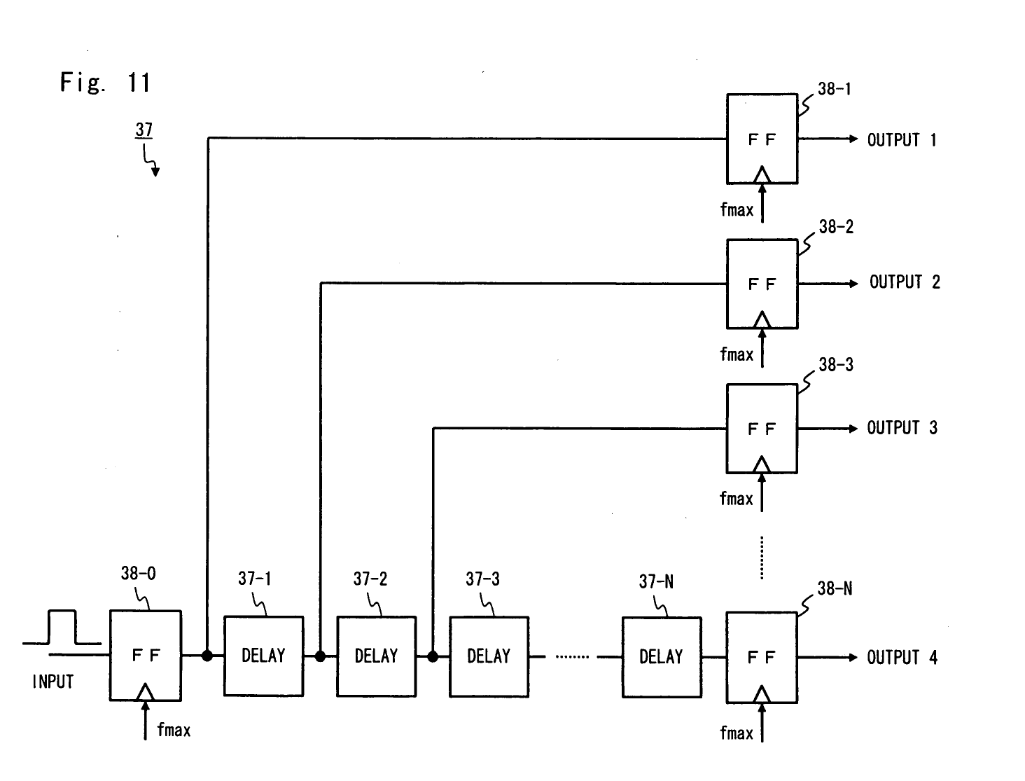

In the first exemplary embodiment, the control circuit 3 as shown in FIG. 4 is used to control the voltage change amount per one step. However, it is not limited to this example. The circuit may have any structure as long as the voltage change amount per one step can be controlled to be proportional to the operable frequency of the target circuit 6. In short, the control circuit as shown in FIG. 10 may be used, for example. This control circuit is composed of the comparator 34, the switch control circuit 35, and a delay ratio monitor 37. An output signal of the delay ratio monitor 37 is input to the switch control circuit 35. The comparison result of the comparator 34, the switching control signal MAX of the selection circuit 5, and the monitor result of the speed monitoring circuit 4 are further input to the switch control circuit 35. The power supply voltage VDD and the maximum voltage VMAX are input to the comparator 34.

FIG. 11 shows the circuit structure of the delay ratio monitor 37. The delay ratio monitor 37 includes FF 38-0 to FF38-N (N is a natural number), and delay elements 37-1 to 37-N. The delay elements 37-1 to 37-N are connected between the FF 38-0 and the FF 38-N in series. Input terminals of the FF 38-1 to FF38-N are connected to a corresponding connection node of the FF 38-0 and the delay elements 37-1 to 37-N (FF 38-N is connected to an output terminal side of the delay element 37-N). In other words, input terminals of the FF 38-1 to FF 38-N are connected to the corresponding output terminals of the FF38-0 and the delay elements 37-1 to 37-N.

The power supply voltage VDD that is equal to that supplied to the target circuit 6 is supplied to the delay elements 37-1 to 37-N. In short, the delay elements 37-1 to 37-N are driven by the power supply voltage VDD as is similar to the target circuit 6. Note that each delay time by each delay element is equal with each other. The clock signal having the same frequency as the maximum operation frequency fmax requested for the target circuit 6 is input to clock input terminals of the FF 38-0 to FF 38-N. The FF38-0 to FF38-N are operated in synchronization with the clock signal.

In the delay ratio monitor 37, the pulse signal is output from the FF 38-0 in synchronization with the rising of the clock signal. The voltage level of each node is output from the FF 38-1 to FF 38-N in synchronization with the rising of the next clock signal. In summary, the delay ratio monitor 37 outputs the number K of nodes where the output signal from the FF 38-0 reaches in one clock cycle. For example, it is assumed that, when the FF 38-0 detect high level, the FF38-1 to FF38-3 detect high level and the other FF38-4 to FF38-N detect low level in synchronization with the rising of the next clock signal. In this case, the delay ratio monitor 37 outputs the information of K=3. The switch control circuit 35 executes control so that the output result K of the delay ratio monitor 37 is proportional to the voltage change amount per one step. By employing such a circuit structure, the current source, the A/D converter, and the like are not needed. Thus, the effect of the present invention can be obtained with smaller area.

### Second Exemplary Embodiment

Next, a power supply voltage control circuit according to the second exemplary embodiment of the present invention will be described. In the power supply voltage control circuit according to the second exemplary embodiment of the present invention, the circuit structures of the control circuit 3 and the selection circuit 5 are different from those shown in FIG. 1. The other circuit structures are similar to those shown in FIG. 1, and thus description will be omitted.

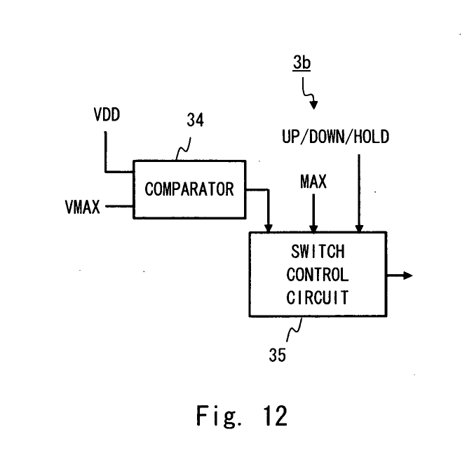

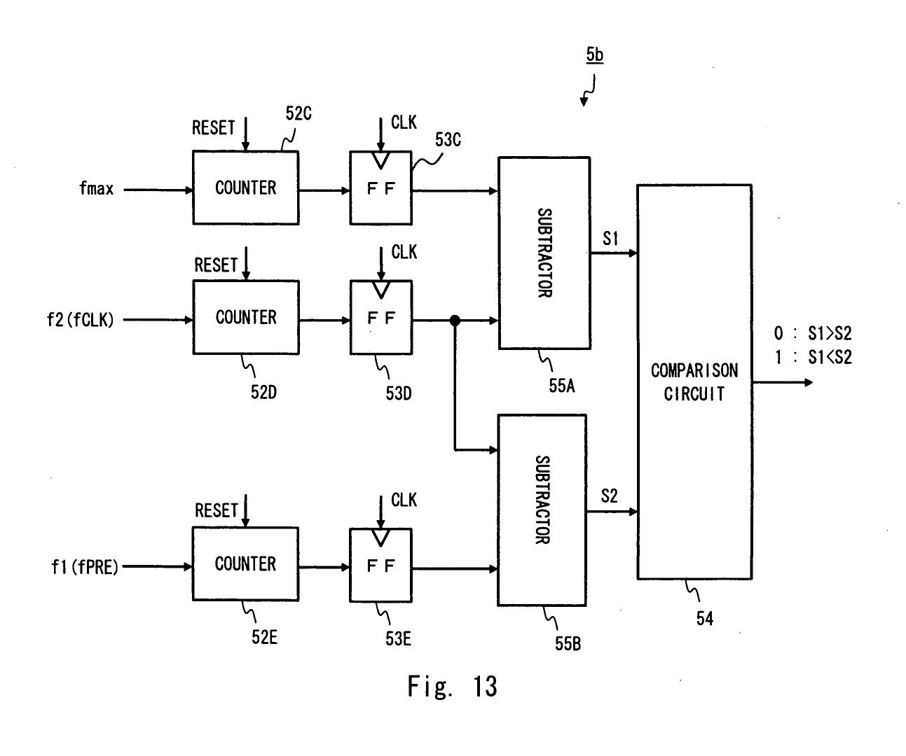

The power supply voltage control circuit according to the second exemplary embodiment of the present invention includes a selection circuit 5b shown in FIG. 13 in place of the selection circuit 5 shown in FIG. 1. Further, the power supply voltage control circuit according to the second exemplary embodiment includes a control circuit 3b shown in FIG. 12 in place of the control circuit 3 shown in FIG. 1. More specifically, the power supply voltage control circuit according to the second exemplary embodiment compares the difference between the request frequency f1 before change and the request frequency f2 after change with the difference between the request frequency f2 and the operation frequency fmax of the target circuit 6 using the selection circuit 5b.

When fmax−f2 is larger than f2−f1, the power supply voltage VDD is monotonically increased until when the operation frequency fop of the target circuit 6 becomes equal to or slightly larger than the request frequency f2. The operation frequency fop of the target circuit 6 is detected from the speed monitoring circuit 4. On the other hand, when fmax−f2 is smaller than f2−f1, the power supply voltage VDD is increased to the maximum voltage VMAX first and subsequently decrease it to the optimal voltage. The optimal voltage is controlled so that the operation frequency fop of the target circuit 6 is equal to or slightly larger than the request frequency f2.

FIG. 12 shows the circuit structure of the control circuit 3b according to the second exemplary embodiment of the present invention. The control circuit 3b includes the comparator 34 that compares the maximum voltage VMAX with the power supply voltage VDD, and the switch control circuit 35. The switch control circuit 35 outputs the control signal to the power supply circuit 2 to control the power supply voltage VDD based on the monitor result (UP/DOWN/HOLD signal) from the speed monitoring circuit 4, the switching control signal MAX from the selection circuit 5b, and the comparison result from the comparator 34.

The comparator 34 compares the power supply voltage VDD with the maximum voltage VMAX, and outputs the comparison result. The comparator 34 outputs the signal to the switch control circuit 35 so as to cancel the switching control signal MAX at a time when the power supply voltage VDD reaches the maximum voltage VMAX. In short, the switch control circuit 35 outputs the control signal (second control signal) to set the power supply voltage VDD to maximum voltage VMAX while the switching control signal MAX is activated. On the other hand, the switch control circuit 35 outputs the control signal to control the power supply voltage VDD in accordance with the UP/DOWN/HOLD signal when the switching control signal MAX is canceled (non-activated). In summary, when the UP signal is output, the switch control circuit 35 outputs the control signal (first control signal) to monotonically increase the power supply voltage VDD to the optimal voltage value. When the DOWN signal is output, the switch control circuit 35 outputs the control signal (third control signal) to monotonically decrease the power supply voltage VDD to the optimal voltage. When the HOLD signal is output, the switch control circuit 35 outputs the control signal (fourth control signal) to keep the power supply voltage VDD. The voltage change amount per one step at this time has constantly a certain value ΔV.

The maximum operation frequency when the request frequency is changed from f1 to f2 (f2>f1) is set as fmax. The minimum voltages that the target circuit 6 can operate with f1, f2, fmax will be denoted by V1, V2, and VMAX, respectively. In general, the operation frequency f can approximately be expressed as f=k (VDD−VTH). Hence, f2−f1 and fmax−f2 are proportional to V2−V1 and VMAX−V2, respectively.

When the power supply voltage VDD is controlled with keeping the voltage change amount per one step constant value ΔV, the following will be obtained. The comparison between the number of control steps required to monotonically increase the power supply voltage VDD and the number of control steps required to monotonically decrease the power supply voltage VDD to the optimal voltage after increasing it to the maximum voltage VMAX is equal to the comparison between f2−f1 and fmax−f2. Hence, the selection circuit 5b according to the second exemplary embodiment outputs the control signal MAX based on the result of comparing f2−f1 with fmax−f2.

FIG. 13 shows the circuit structure of the selection circuit 5b according to the second exemplary embodiment. The selection circuit 5b includes counters 52C, 52D, 52E, FFs 53C, 53D, 53E, subtractors 55A, 55B, and a comparison circuit 54. A clock signal of the frequency fmax is input to the counter 52C. A clock signal fCLK of the frequency f2 is input to the counter 52D. A clock signal fPRE of the frequency f1 is input to the counter 52E. Further, reset signals are input to the counter circuits 52C, 52D, 52E.

An output signal of the counter circuit 52C is input to an input terminal of the FF 53C. An output signal of the FF 53C is input to one input terminal of the subtractor 55A. An output signal of the counter circuit 52D is input to an input terminal of the FF 53D. An output signal of the FF 53D is input to the other input terminal of the subtractor 55A and one input terminal of the subtractor 55B. An output signal of the counter circuit 52E is input to an input terminal of the FF 53E. An output signal of the FF 53E is input to the other input terminal of the subtractor 55B. Further, a clock signal CLK of any frequency is input to each clock input terminal of the FF 53C, FF 53D, FF 53E. The selection circuit 5b shown in FIG. 13 may be formed, as is similar to the selection circuit 5 shown in FIG. 8, so that the clock signal input to each FF and the reset signal of each corresponding counter may be common each other.

The counter 52C starts count of the clock signal of the frequency fmax after the reset signal is changed to “0”, for example. The FF 53C receives the count number N0 of the counter 52C in synchronization with the clock signal CLK. The counter 52D starts count of the clock signal fCLK of the frequency f2 after the reset signal is changed to “0”, for example. The FF 53D receives the count number N2 of the counter 52D in synchronization with the clock signal CLK. The counter 52E starts count of the clock signal fPRE of the frequency f1 after the reset signal is changed to “0”, for example. Then, the FF 53E receives the count number N1 of the counter 52E in synchronization with the clock signal.

In the subtractor 55A, the calculation result of N0−N2 is output. In the subtractor 55B, the calculation result of N2−N1 is output. The magnitude relation of the calculation result in each subtractor is compared by the comparison circuit 54. When N2−N1 >N0−N2, or f2−f1>fmax−f2, “1” is output as the control signal MAX, and otherwise “0” is output. In the second exemplary embodiment, the request frequency f2 when fmax−f2=f2−f1 is called reference frequency.

As described above, by employing the power supply voltage control circuit according to the second exemplary embodiment of the present invention, the optimal power supply voltage control method can be selected according to the change of the request frequency. Hence, the time required to control the power supply can be minimized. Further, the increase of the power consumption can be suppressed. Further, in the second exemplary embodiment, the control circuit does not include the threshold voltage generation circuit, the difference voltage generation circuit, the A/D converter and the like, whereby the circuit can be implemented with smaller size.

### Third Exemplary Embodiment

A power supply voltage control circuit according to the third exemplary embodiment of the present invention will now be described. In the power supply voltage control circuit according to the third exemplary embodiment of the present invention, the circuit structure of the control circuit 3 is different from that of the circuit shown in FIG. 1. The other circuit structures are similar to those shown in FIG. 1, and thus description will be omitted.

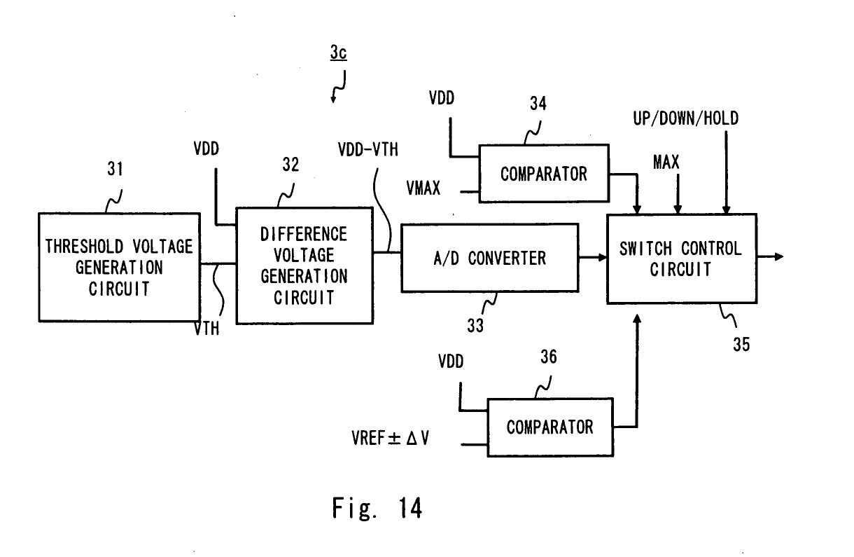

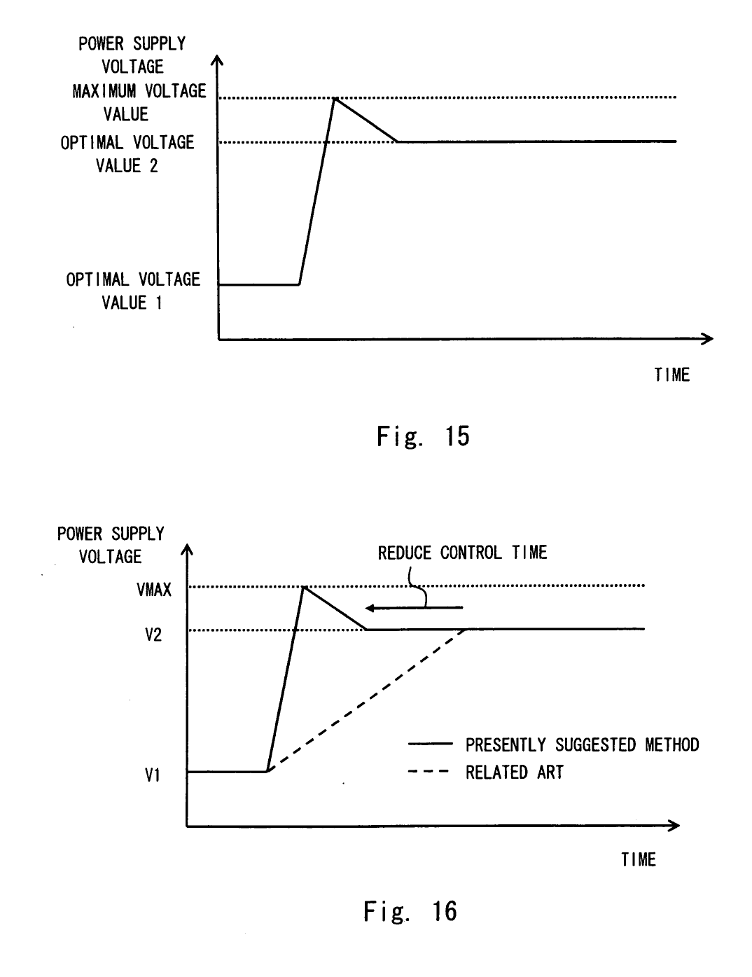

The power supply voltage control circuit according to the third exemplary embodiment of the present invention includes a control circuit 3c shown in FIG. 14 in place of the control circuit 3 shown in FIG. 1. The control circuit 3c includes the threshold voltage generation circuit 31 that generates the threshold voltage VTH of the critical path in the target circuit 6, the difference voltage generation circuit 32 that outputs the difference voltage between the power supply voltage VDD and the threshold voltage VTH, the A/D converter 33 that converts the output of the difference voltage generation circuit 32 to a digital value, the comparator 34 that compares the maximum voltage VMAX that can be supplied to the target circuit 6 with the power supply voltage VDD, the switch control circuit 35, and a comparator 36. The circuit structure and the operation of the threshold voltage generation circuit 31, the difference voltage generation circuit 32, the A/D converter 33, and the comparator 34 are similar to those shown in FIG. 1, and thus description will be omitted.

The switch control circuit 35 according to the third exemplary embodiment outputs the control signal to the power supply circuit 2 to control the power supply voltage VDD based on the monitor result (UP/DOWN/HOLD signal) from the speed monitoring circuit 4, the switching control signal MAX from the selection circuit 5, the comparison result from the comparator 34, and the output signal from the A/D converter 33.

The voltage change amount per one step that is determined based on the output of the A/D converter 33 is called VSTEP. When the UP signal is output from the speed monitoring circuit 4, the switch control circuit 35 outputs the control signal to increase the voltage change amount of the reference voltage VREF generated by the reference voltage generation circuit 21 as VSTEP+ΔV. After that, the comparator 36 detects that the power supply voltage VDD has reached VREF−ΔV. At this time, the switch control circuit 35 outputs the control signal to control the voltage change amount of the reference voltage VREF by reducing it by ΔV (which means the voltage change amount is set to VSTEP). ΔV is any positive voltage value.

On the other hand, when the DOWN signal is output from the speed monitoring circuit 4, the switch control circuit 35 outputs the control signal to decrease the voltage change amount of the reference voltage VREF as VSTEP+ΔV. After that, the comparator 36 detects that the power supply voltage VDD has reached VREF+ΔV. At this time, the switch control circuit 35 outputs the control signal to control the voltage change amount of the reference voltage VREF by reducing it by ΔV (which means that the voltage change amount is set to VSTEP).

In general, when the reference voltage is changed in the power supply voltage control circuit that controls the output voltage according to the reference voltage, the change rate of the output voltage increases as the change amount of the reference voltage is large. Hence, it is possible to shorten the convergence time of the power supply voltage VDD by temporarily increasing the change amount of the reference voltage as in the third exemplary embodiment. Further, the detection intervals in the speed monitoring circuit 4 can be shortened.

As described above, by employing the power supply voltage control circuit according to the third exemplary embodiment of the present invention, the optimal power supply voltage control method can be selected according to the change of the request frequency. Hence, the time required to control the power supply can be minimized. Further, the increase of the power consumption can be suppressed. Further, in the third exemplary embodiment, the detection intervals in the speed monitoring circuit 4 can be shortened. In summary, by increasing the change amount of the power supply voltage VDD per one step of the voltage control, the time required to control the power supply of the speed monitoring circuit 4 can further be reduced.

The present invention is not limited to the above exemplary embodiments but can be changed as appropriate without departing from the spirit of the present invention. For example, although ΔV is assumed to be any positive constant in the third exemplary embodiment, ΔV may be changed to be proportional to VSTEP. By performing such a control, the occurrence of ringing in the power supply voltage VDD can be suppressed when VSTEP is small.

Further, when VSTEP is small, the circuit may have the structure that controls ΔV to be 0. When the UP signal is input to the switch control circuit 35, the control signal is output to increase the reference voltage VREF by VSTEP. On the other hand, when the DOWN signal is input to the switch control circuit 35, the control signal is output to decrease the reference voltage VREF by VSTEP. In summary, the function of the comparator 36 can be made invalid. By performing such a control, malfunction of the comparator 36 by the input offset voltage can be prevented. Alternatively, the control circuit according to the third exemplary embodiment may have the circuit structure having a comparator 36 added to the control circuit shown in FIG. 10.

In the voltage control of the charge pump circuit disclosed in Japanese Unexamined Patent Application Publication No. 2004-248475, when the target voltage is constant, the difference between the minimum voltage and the maximum value of the voltage fluctuation is minimized. On the other hand, in the power supply voltage control circuit according to the above exemplary embodiments of the present invention, when the target voltage value itself is changed, the voltage is converged into the target voltage value after change as soon as possible. Thus, in the power supply voltage control circuit according to the above exemplary embodiments, the object and the effect are different from those in Japanese Unexamined Patent Application Publication No. 2004-248475.

Further, the power supply voltage control circuit according to the above exemplary embodiments include a control method not only to converge the power supply voltage VDD to the target voltage but to rapidly increase the power supply voltage VDD to the target voltage or higher than the target voltage. In short, according to this control method, the power supply voltage VDD is rapidly increased to the voltage at which the target circuit can normally operate. Thus, the control method of the power supply voltage is also different from the one disclosed in Japanese Unexamined Patent Application Publication No. 2004-248475.

The first to third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A power supply voltage control circuit that controls power supply voltage supplied to a target circuit, the target circuit performing certain signal processing, the power supply voltage control circuit comprising:
a control signal generation circuit that selectively generates first and second control signals when the power supply voltage supplied to the target circuit is increased from a first power supply voltage to a second power supply voltage, the second power supply voltage being higher than the first power supply voltage; and
a power supply circuit that increases the power supply voltage toward a voltage level of the second power supply voltage based on the first control signal, or increases the power supply voltage to a voltage level higher than the second power supply voltage first and subsequently decreases the power supply voltage to the second power supply voltage based on the second control signal.

2. The power supply voltage control circuit according to claim 1, further comprising a delay time detection circuit that detects delay time of signal processing in the target circuit, wherein
the control signal generation circuit determines the voltage level of the second power supply voltage based on the delay time detected by the delay time detection circuit.

3. The power supply voltage control circuit according to claim 1, further comprising a selection circuit that, when a clock signal input to the target circuit is switched from a first clock signal to a second clock signal, generates a switching control signal and outputs the switching control signal to the control signal generation circuit, the switching control signal being for selecting one of the first and the second control signals based on operation frequencies of the first and the second clock signals and maximum operation frequency corresponding to power supply voltage of a maximum voltage level that can be supplied to the target circuit.

4. The power supply voltage control circuit according to claim 1, wherein, when a clock signal input to the target circuit is switched from a first clock signal to a second clock signal, the control signal generation circuit generates the first control signal when operation frequency of the second clock signal is smaller than a reference frequency, the reference frequency being determined based on operation frequency of the first clock signal and maximum operation frequency corresponding to power supply voltage of a maximum voltage level that can be supplied to the target circuit, and
the control signal generation circuit generates the second control signal when the operation frequency of the second clock signal is larger than the reference frequency.

5. The power supply voltage control circuit according to claim 1, wherein the power supply circuit increases the power supply voltage to a maximum voltage level that can be supplied to the target circuit and subsequently monotonically decreases the power supply voltage to the second power supply voltage based on the second control signal.

6. The power supply voltage control circuit according to claim 1, wherein the power supply circuit monotonically increases the power supply voltage to the first power supply voltage based on the first control signal.

7. The power supply voltage control circuit according to claim 2, wherein the delay time detection circuit comprises a replica circuit having a delay time that is substantially equal to delay of a critical path of the target circuit.

8. The power supply voltage control circuit according to claim 7, wherein the replica circuit has circuit structure that is equal to that of the target circuit.

9. The power supply voltage control circuit according to claim 1, wherein the control signal generation circuit generates a third control signal when the power supply voltage is decreased from the first power supply voltage to a third power supply voltage, the third power supply voltage being lower than the first power supply voltage, and
the power supply circuit decreases the power supply voltage toward the third power supply voltage based on the third control signal.

10. The power supply voltage control circuit according to claim 1, wherein the control signal generation circuit generates a fourth control signal to keep the power supply voltage, and
the power supply circuit keeps the power supply voltage based on the fourth control signal.

11. The power supply voltage control circuit according to claim 1, wherein the control signal generation circuit generates a third control signal to decrease the power supply voltage from the first power supply voltage to the third power supply voltage, the third power supply voltage being lower than the first power supply voltage,
the control signal generation circuit generates a fourth control signal to keep the power supply voltage, and
the voltage control circuit selectively generates the first or the second control signal, the third control signal, and the fourth control signal based on delay information obtained from the delay time detection circuit.

12. The power supply voltage control circuit according to claim 1, wherein, when the power supply voltage is monotonically increased from the first power supply voltage to the second power supply voltage, the control signal generation circuit monotonically increases the power supply voltage toward a voltage level higher than the second power voltage, and subsequently increases the power supply voltage to the second power supply voltage before the voltage level reaches the second power supply voltage.
